(19) United States
(12) Patent Application Publication
(10) Pub. No.: US 2008/0232819 A1
(43) Pub. Date: Sep. 25, 2008

(54) Pon System and Optical Network Unit Connecting Method

(76) Inventor: Hiroaki Mukai, Tokyo (JP)

Correspondence Address: BIRCH STEWART KOLASCH & BIRCH, PO BOX 747, FALLS CHURCH, VA, 22040-0747, US

(21) Appl. No.: 10/573,047

(22) PCT Filed: Nov. 5, 2003
(86) PCT No.: PCT/JP03/14112

§ 371 Date: Mar. 22, 2006

(51) Int. Cl. H04B 10/00

(52) U.S. Cl. 398/168

(57) ABSTRACT

In a passive optical network system, upon detecting a connection with one of a plurality of optical network units at the time of performing autonomous ranging, an optical line termination requests for subscriber recognition information from the connected optical network unit, searches a database, to thereby specify the subscriber and the service details, and performs bandwidth setting and connection setting based on specified service details. The optical network unit stores the subscriber recognition information input by a subscriber, in association with the subscriber information.

### TECHNICAL FIELD

The present invention relates to a passive optical network (hereinafter, “PON system”), in which an optical line termination and a plurality of optical network units perform 1-to-N communications via an optical transmission line, and an optical network unit connecting method.

### BACKGROUND ART

A conventional system disclosed in Non-Patent Document 1 is a known example of a PON system. Portions of the conventional PON system disclosed in Non-Patent Document 1 that are relevant to the present invention will now be described in outline with reference to FIGS. 1 to 5.

FIG. 1 is a block diagram of an exemplary configuration of the conventional PON system. The PON system shown in FIG. 1 includes a plurality of optical network units (hereinafter, “ONUs”) 120 connected via an optical transmission line 130 to an optical line termination (hereinafter, “OLT”) 100. An operations system (hereinafter, “OpS”) 140, which is operated by a telecommunications firm, is connected to the OLT 100.

The optical transmission line 130 includes a single trunk optical fiber 131, one end of which is connected to the OLT 100, a plurality of branch optical fibers 132, one end of each being connected to one of the ONUs 120, and a splitter 133, which is an optical branch coupler that connects the other end of the trunk optical fiber 131 to the other ends of the branch optical fibers 132.

The OLT 100 has a physical layer terminating unit 101 that terminates the physical layer at the OLT, a service node interfacing unit 102 that connects the physical layer terminating unit 101 to various external service nodes, a database 103 that stores operation parameters of the OLT, and a monitoring/controlling unit 104 that monitors and controls the respective components mentioned above and sets various settings inside the OLT.

Each ONU 120 has a physical layer terminating unit 121 that terminates the physical layer at the ONU, a user interfacing unit 122 that connects a terminal (not shown) to the physical layer terminating unit 121, a monitoring/controlling unit 123 that monitors and controls the physical layer terminating unit 121 and sets various settings inside the ONU, and a unit number storing unit 124 that stores a unit number (serial number), which is provided during the manufacture of the ONU, and which is used by the physical layer terminating unit 121.

FIGS. 2A to 2C are conceptual diagrams for explaining forms of communications performed between the OLT and the ONU. In these diagrams, cases where three ONUs 120a, 120b, and 120c of a subscriber A, a subscriber B, and a subscriber C communicate with the OLT 100 are shown. FIG. 2A is a diagram depicting a form of a downlink signal sent from the OLT to the ONUs. FIG. 2B is a diagram depicting the form of uplink signals sent from the ONUs to the OLT.

As shown in FIG. 2A, the downlink signals A, B, and C that the OLT 100 sends to the ONUs 120a, 120b, and 120c is broadcast from the trunk optical fiber 131 to the respective branch optical fibers 132. Each of the three ONUs 120a, 120b, and 120c is configured to input the signal addressed to itself from among the downlink signals A, B, and C received.

As shown in FIG. 2B, the three ONUs 120a, 120b, and 120c send uplink signals to the branch optical fibers 132 at timings such that the uplink signals transmitted to the branch optical fibers are time division multiplexed in the trunk optical fiber 131. To realize this, the OLT 100 uses the identification information of the respective ONUs to schedule the sending time of the uplink signal of the respective ONUs so that the uplink signals from the respective ONUs will not collide and uses a downlink control signal to notify to the respective ONUs the sending timings at which the uplink signals will not collide.

FIG. 3 is a diagram for explaining timing control of sending the uplink signal performed by the OLT. In FIG. 3, the OLT assigns the identification information, “01,” “02,” and “03” to the three ONUs respectively to schedule the uplink signal sending time, and uses a sending enabling signal 301, which is a downlink control signal, to designate a time slot T1 for the ONU_01, a time slot T2 for the ONU_02, and a time slot T3 for the ONU_03. The uplink signals to the OLT are thereby time division multiplexed without colliding.

As can be understood from the explanation of FIG. 3, when an ONU is to be connected a new to the PON system, the OLT must provide identification information to the newly connected ONU. In this process, a plurality of ONUs may be connected simultaneously to the PON system. The OLT thus requires a mechanism that can provide identification information respectively to each ONU. A unique unit number is provided to an ONU when it is manufactured, and hence, to realize the mechanism, the OLT acquires and registers the unit numbers by either of two methods to be described below (see FIGS. 4 and 5), and provides identification information to the respective ONUs by designating the registered unit numbers.

Methods of registering the unit numbers of ONUs in the database 103 of the OLT 100 will now be described with reference to FIGS. 4 and 5. FIGS. 4A to 4C are diagrams for explaining a method whereby an operator (telecommunications firm) registers the unit numbers of the ONUs in the OLT 100 using the OpS 140. This method is premised on the operator knowing in advance the unit numbers of the ONUs to be connected to the OLT 100.

FIG. 4A depicts a state in which ONUs 120d and 120e, which have unit numbers “S/N=00800002” and “S/N=00000501” respectively, are to be installed anew.

In FIG. 4B, the operator uses the OpS 140 to input the unit numbers “S/N” of the two ONUs 120d and 120e into the OLT 100. In the OLT 100, the monitoring/controlling unit 104 allocates the identification information “01” and “02”, and stores the unit numbers in the database 103. Thus, “ONU_01:S/N=00000501” and “ONU_02:S/N=00800002” are stored in the database 103.

In FIG. 4C, the monitoring/controlling unit 104 of the OLT sets the unit numbers, which are read from the database 103, into the physical layer terminating unit 101. The physical layer terminating unit 101 cyclically repeats an identification information providing procedure until the provision of the identification information to the ONUs with the set unit numbers is completed. In each of the ONUs 120d and 120e, the physical layer terminating unit 121 responds only when the unit number designated by the identification information providing procedure performed by the OLT 100 matches the unit number (S/N=00800002 or S/N=00000501) provided at the time of manufacture of the ONU. The identification information ONU_02 is thereby provided to the ONU 120d, and the identification information ONU_01 is provided to the ONU 120e.

FIGS. 5A to 5C are diagrams for explaining a method whereby the OLT 100 autonomously acquires the unit numbers of the ONUs. With this method, the operator does not need to know in advance the unit numbers of the ONUs to be connected to the OLT 100.

FIG. 5A depicts a state in which ONUs 120f and 120g, which have unit numbers “S/N=00000501” and “S/N=00800002” respectively, are to be installed anew.

In FIG. 5B, the ONUs 120f and 120g are not provided with identification information. The physical layer terminating unit 101 of the OLT 100, cyclically or according to an instruction based on an operator operation from the OpS 140, enables the ONUs 120f and 120g to send uplink messages that notify the unit numbers of the ONUs. In each of the ONUs 120f and 120g that has been enabled by the OLT 100 to perform sending, a physical layer terminating unit 201 sends the unit number (S/N=00000501 or S/N=00800002) provided at the time of manufacture and stored in the unit number storing unit 124. In the OLT 100, upon receiving the uplink message containing the unit number (S/N=00000501 or S/N=00080002) of the ONU 120f or 120g, the monitoring/controlling unit 104 inputs the unit number into the database 103.

In FIG. 5C, the monitoring/controlling unit 104 of the OLT assigns the identification information “01” and “02” to the unit numbers (S/N=00000501 and S/N=00080002) of the ONUs 120f and 120g that were input into the database 103. Thus, “ONU_01: S/N=00000501” and “ONU_01: S/N=00800002” are stored in the database 103. The monitoring/controlling unit 104 then sets the unit numbers, read from the database 103, in the physical layer terminating unit 101. Thereafter, the same identification information providing procedure as that of FIG. 4C is performed, and the identification information ONU_01 is provided to the ONU 120f, and the identification information ONU_02 is provided to the ONU 120g.

With the PON system here, the OLT sets for each ONU, a delay time between the point at which the ONU receives the send enabling signal and the point at which the uplink data are sent. This is done because the response time of the ONUs differ according to the distance from the OLT to the ONUs, and by setting delay time for the respective ONUs individually, the response time is made uniform at a fixed value and the uplink signals are multiplexed without gaps at the OLT receiving terminal.

The identification information providing procedure and the delay time setting together are referred to as a “ranging process,” and the state of an ONU for which the ranging process has been completed is defined as an “operating state.” The method depicted in FIG. 4, in which the operator (telecommunications firm) registers the unit numbers of the ONUs in the OLT from the OpS is defined as the “ranging method A”, and the method depicted in FIG. 5, in which the OLT autonomously acquires the unit numbers of the ONUs is defined as the “ranging method B.”

Various settings such as bandwidths, access points, and the like, which are based on contracts made with the respective subscribers, are necessary to provide communication services to subscribers. Measures must also be taken so that services are not provided to customers who have not made contracts or have not paid fees. Thus, not only the unit number of an ONU, but information concerning the subscriber that uses the ONU must also be managed in the OLT.

In the ranging method A, the installation of an ONU at a subscriber's place based on a contract (FIG. 4A) is carried out in linkage with the registration of the unit number (S/N) in the OLT (FIG. 4B), and hence, the operator (telecommunications firm) has knowledge of the association between the subscriber and the ONU unit-number. That is, the association between the ONU unit number and the subscriber, and the contracted service details can be set in the OLT. The OLT can thus begin to provide services according to the contract details, immediately after the completion of the ranging process on the registered ONU.

Meanwhile, in the ranging method B, though an ONU can be put in the operating state even if the operator (telecommunications firm) does not know the unit number of the ONU to be connected to the OLT, only the contracted service details will be set in the database of the OLT. Thus, the OLT cannot specify which subscriber the acquired unit number belongs to, and hence, the OLT can neither judge whether the subscriber is one who has made the contract, nor specify the contracted service details, and thus, cannot provide services immediately after ONU connection of the subscriber.

Due to such reasons, the ranging method A has been employed in conventional PON systems. However, requests have been increasing for enabling accommodation to environments in which a subscriber purchases an ONU from a mass retailer, etc., and connects to an OLT on his/her own (such an environment is hereinafter, “open terminal environment”). In regard to this request, the ranging method A cannot accommodate an open terminal environment because the telecommunications firm must manage the ONU, which is an in-house device.

The construction of a PON system, whereby the ranging method B that can accommodate open terminal environments can be implemented, is thus necessary. However, an issue is how the OLT can be made to specify subscribers under the open terminal environment.

The Non-Patent Document 1 is as follows.

Non-Patent Document 1: ITU-T Recommendations G.983.1 (SERIES G: TRANSMISSION SYSTEMS AND MEDIA, DIGITAL SYSTEMS AND NETWORKS)

Digital transmission systems-Digital section and digital line system-Optical line systems for local and access

Broadband optical access based on Passive Optical Networks (PON)

The present invention has been made in view of the above and an object thereof is to provide a PON system and an optical network unit connecting method that enable services to be started immediately after performing autonomous ranging for ONUs purchased and installed by subscribers under an open terminal environment.

### DISCLOSURE OF INVENTION

According to the present invention, in a PON system, a plurality of optical network units are respectively connected via an optical transmission line to an optical line termination, the optical line termination includes a database that stores subscriber recognition information and service details according to each subscriber; a unit that, upon detecting a connection of a new optical network unit in performing autonomous ranging, issues a control message that requests the newly connected optical network unit to provide subscriber recognition information and acquires the subscriber recognition information; and a unit that, based on the acquired subscriber recognition information, searches the database and specifies the subscriber and the service details and performs bandwidth setting and connection setting based on the specified service details; and each of the optical network units includes a unit that holds subscriber recognition information input by a subscriber; and a unit that receives a control message that requests the subscriber recognition information from the optical line termination and issues a response message that notifies the subscriber recognition information.

With the present invention, the optical line termination, that is, the PON system can realize a plug-and-play function that enables services to be started immediately after performing autonomous ranging for optical network units purchased and installed by subscribers under an open terminal environment.

### BRIEF DESCRIPTION OF DRAWINGS

FIG. 1 is a block diagram of an example configuration of a conventional PON system,

FIGS. 2A to 2C are conceptual diagrams for explaining forms of communications carried out between an OLT and ONUs shown in FIG. 1,

FIG. 3 is a diagram for explaining timing control of sending an uplink signal that the OLT shown in FIG. 1 performs,

FIGS. 4A to 4C are diagrams for explaining a method by which an operator (telecommunications firm) registers unit numbers of the ONUs in the OLT using an OpS shown in FIG. 1,

FIGS. 5A to 5C are diagrams for explaining a method by which the OLT shown in FIG. 1 autonomously acquires the unit numbers of the ONUs,

FIG. 6 is a block diagram of a PON system according to a first embodiment of the present invention,

FIG. 7 is a sequence diagram for explaining an optical network unit connecting procedure implemented in the PON system shown in FIG. 6,

FIG. 8 is a block diagram of a PON system according to a second embodiment of the present invention,

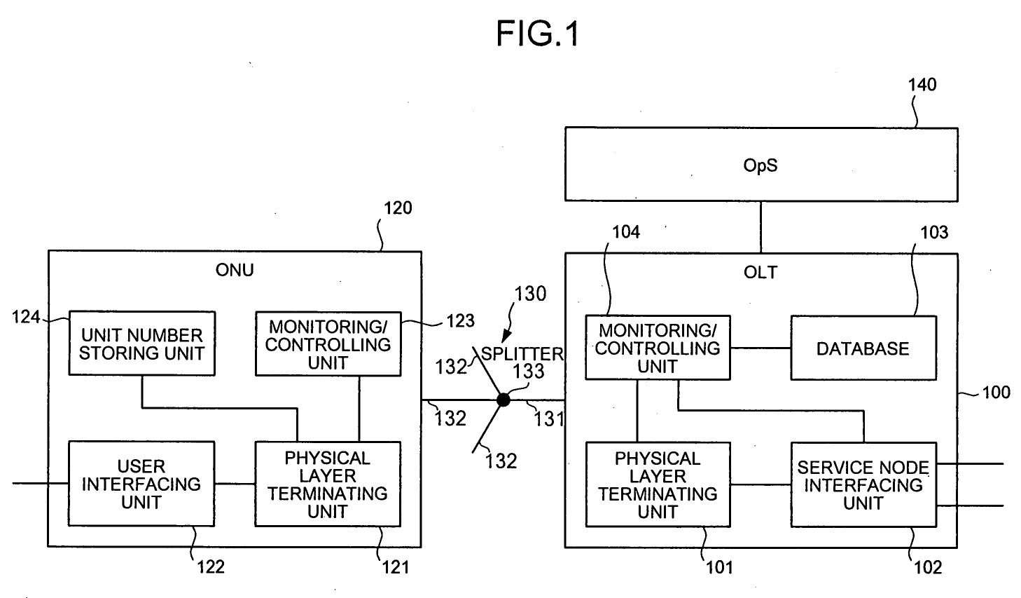

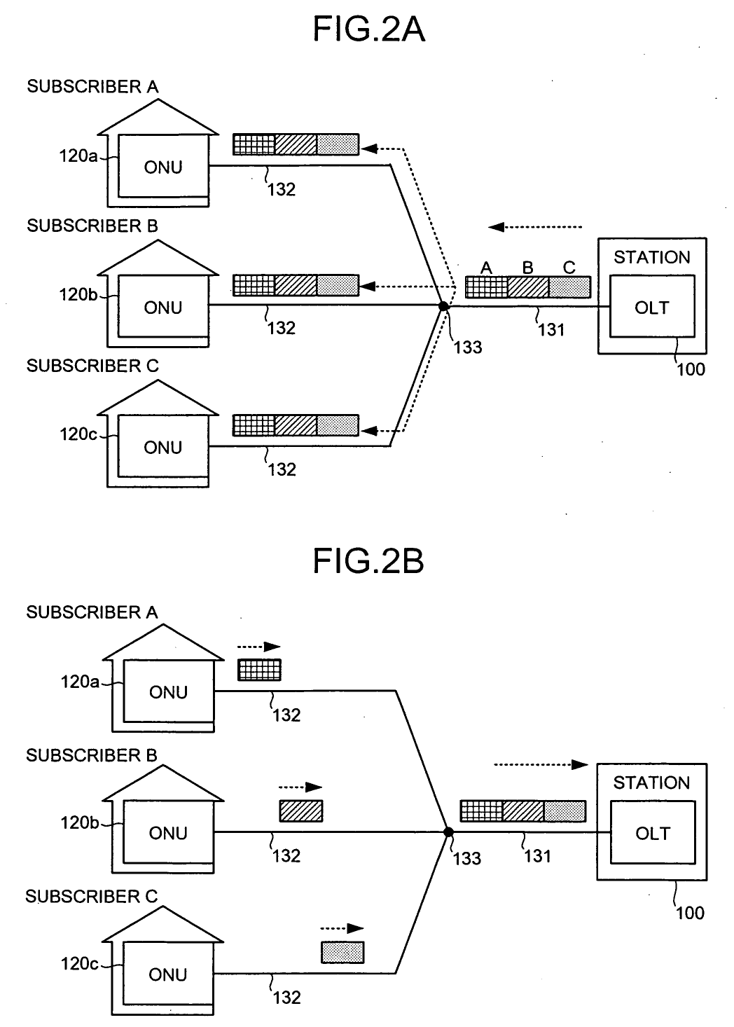

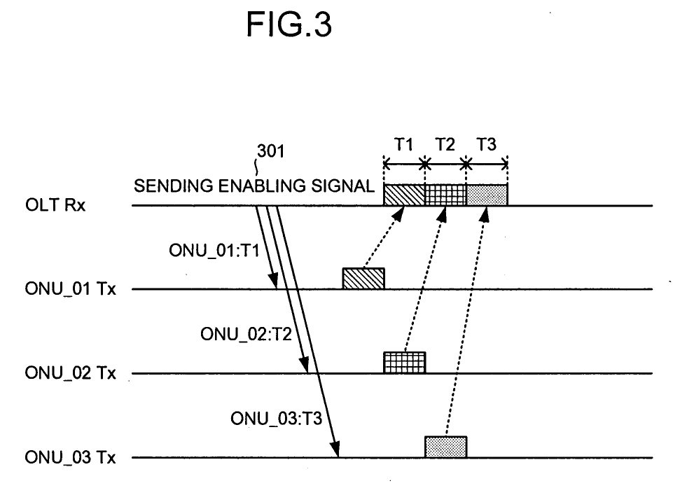

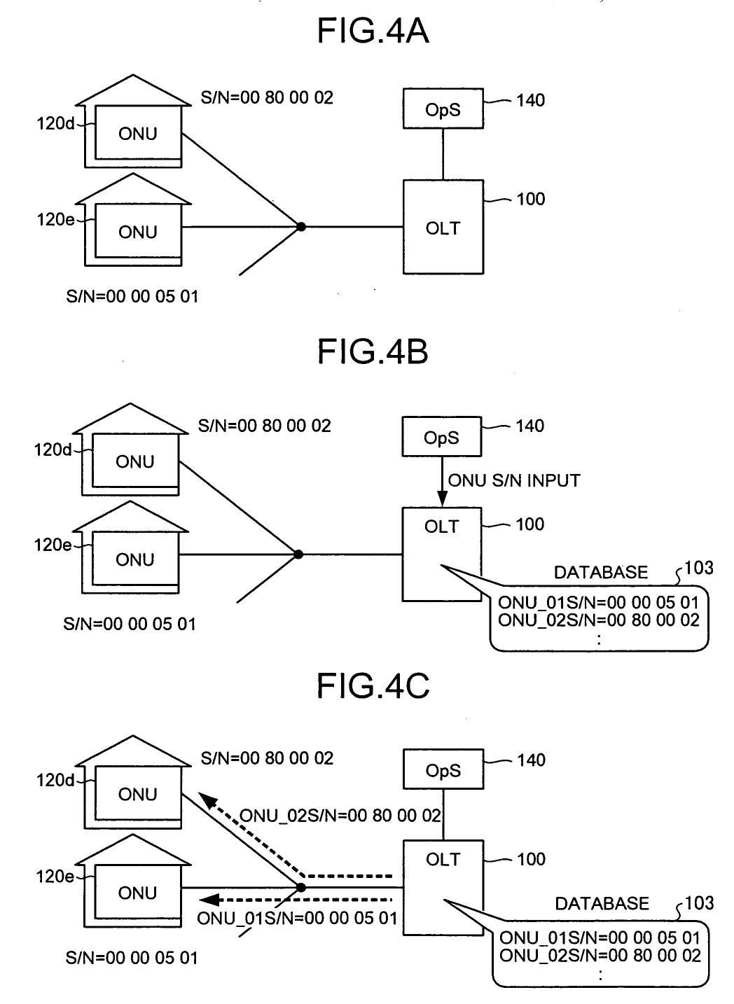

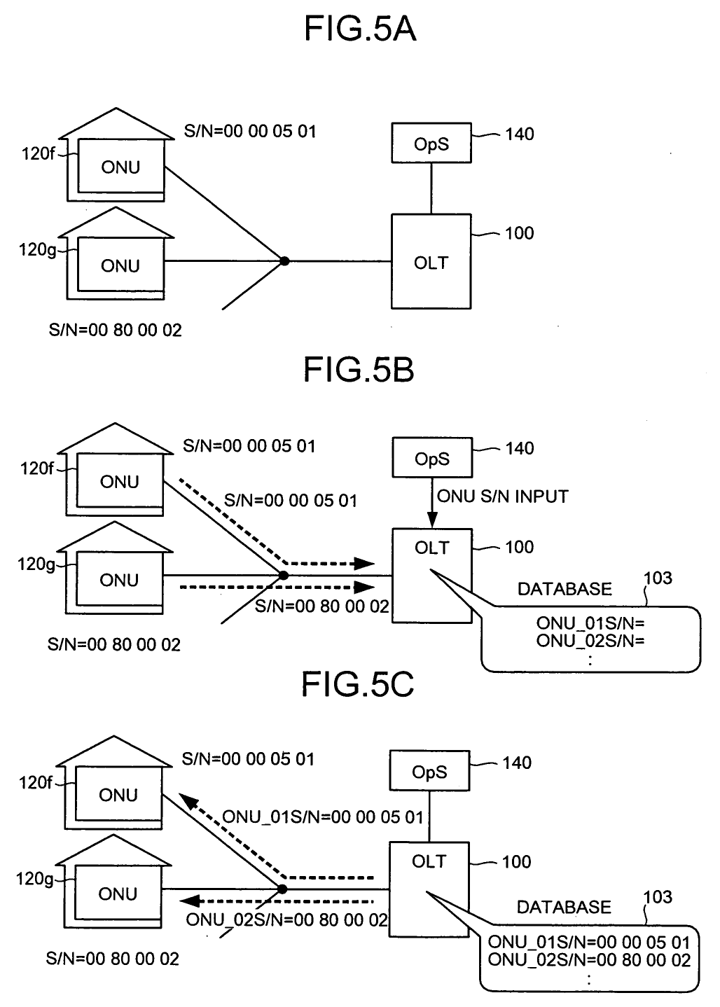

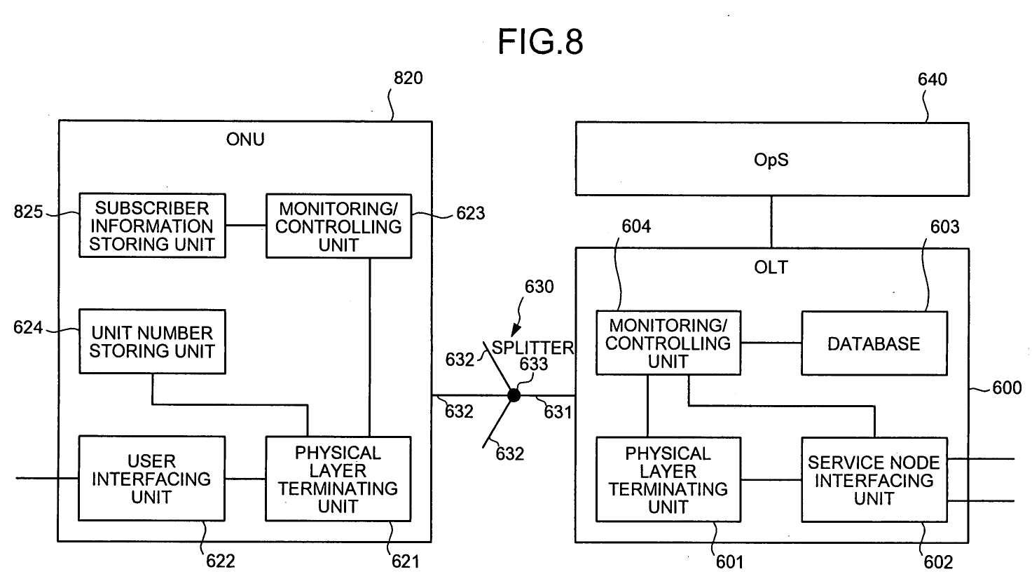

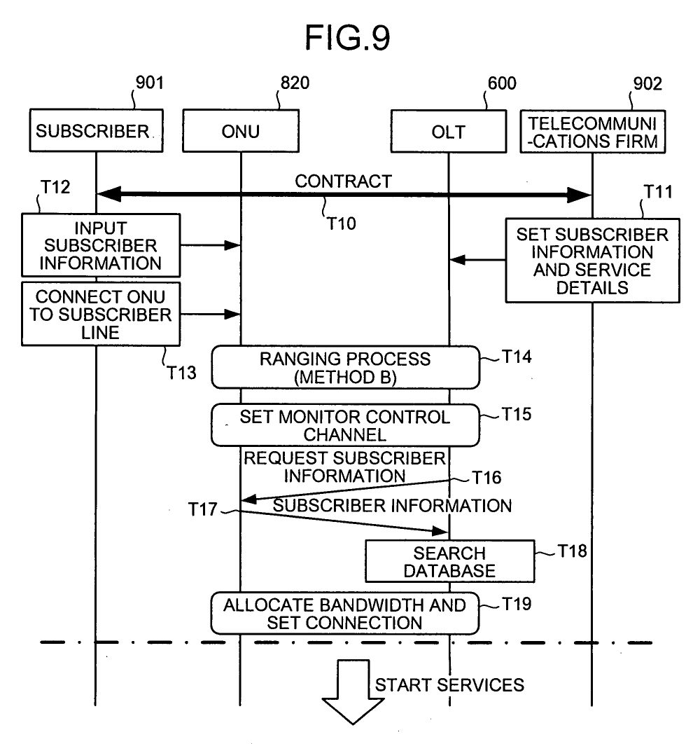

and FIG. 9 is a sequence diagram for explaining an optical network unit connecting procedure implemented in the PON system shown in FIG. 8.

### BEST MODE(S) FOR CARRYING OUT THE INVENTION

Exemplary embodiments of a PON system and an optical network unit connecting method according to the present invention will now be described in detail with reference to the accompanying drawings.

### First Embodiment

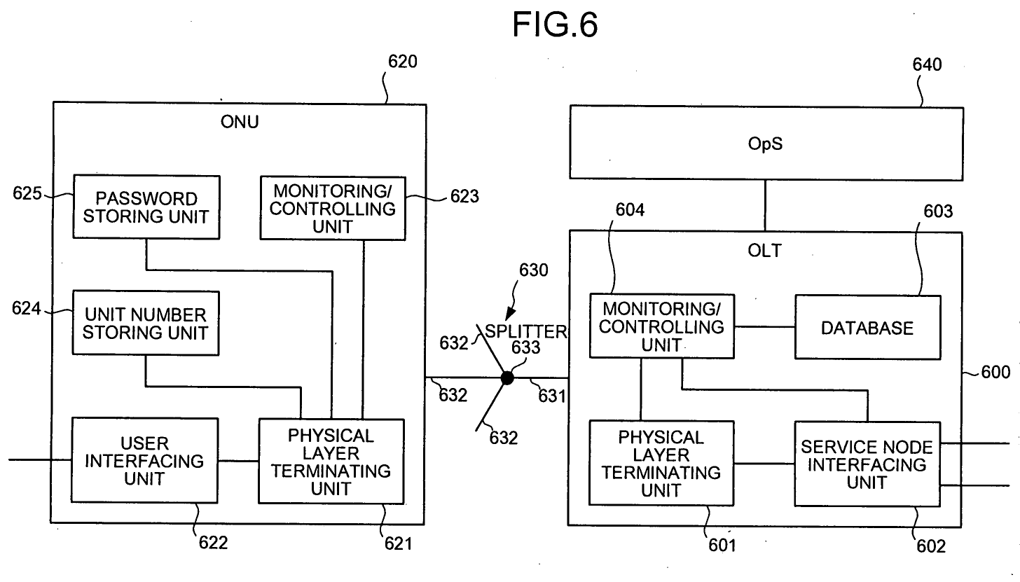

FIG. 6 is a block diagram of a PON system according to a first embodiment of the present invention. In the PON system shown in FIG. 6, a plurality of optical network units (hereinafter, “ONUs”) 620 are connected via an optical transmission line 630 to an optical line termination (hereinafter, “OLT”) 600. An operations system (hereinafter, “OpS”) 640, which is operated by a telecommunications firm, is connected to the OLT 600.

The optical transmission line 630 includes a single trunk optical fiber 631, one end of which is connected to the OLT 600, a plurality of branch optical fibers 632, the ends at one side of which are connected respectively to the ONUs 620, and a splitter 633, which is an optical branch coupler that connects the other end of the trunk optical fiber 631 to the other ends of the branch optical fibers 632.

The OLT 600 has a physical layer terminating unit 601 that terminates the physical layer at the OLT, a service node interfacing unit 602 that connects the physical layer terminating unit 601 with various external service nodes, a database 603 that stores operation parameters of the OLT, and a monitoring/controlling unit 604 that monitors and controls the respective components mentioned above and sets various settings inside the OLT.

Each ONU 620 has a physical layer terminating unit 621 that terminates the physical layer at the ONU, a user interfacing unit 622 that connects a terminal (not shown) to the physical layer terminating unit 621, a monitoring/controlling unit 623 that monitors and controls the physical layer terminating unit 621 and sets various settings inside the ONU, a unit number storing unit 624 that stores a unit number (serial number) provided during the manufacture of the ONU and makes the unit number be used in using the physical layer terminating unit 621, and a password storing unit 625 that stores a password set by a subscriber and makes the password be used in using the physical layer terminating unit 621.

In an example described in the first embodiment, PLOAM (Physical Layer Operation and Maintenance) messages, which are physical layer control messages, are used as a method of realizing a plug-and-play function of starting services immediately upon specifying a new subscriber in an open terminal environment.

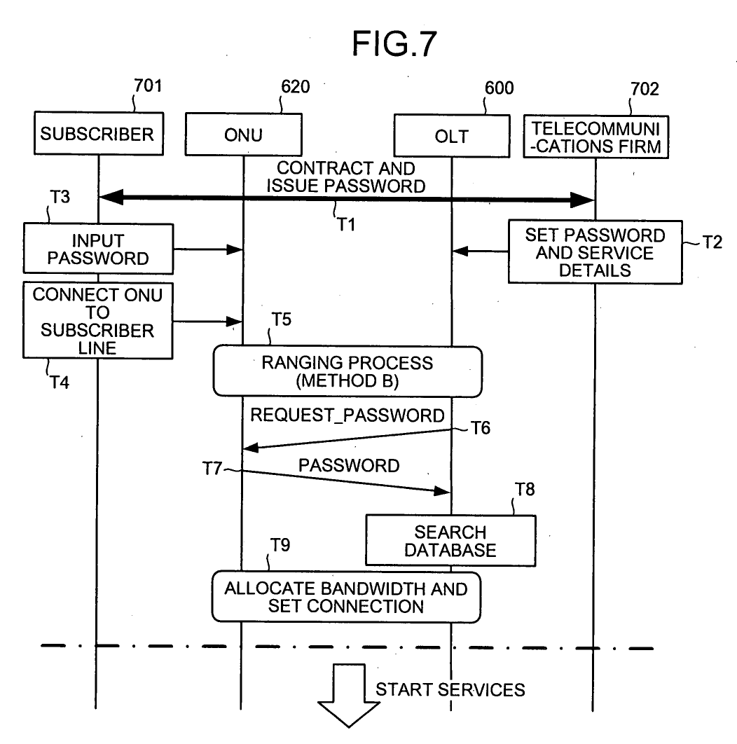

The plug-and-play function realized by the PON system shown in FIG. 6 will now be described with reference to FIG. 7. FIG. 7 is a sequence diagram for explaining an optical network unit connecting procedure implemented in the PON system shown in FIG. 6.

In procedure T1 in FIG. 7, a subscriber 701 and a telecommunications firm 702 bind a contract and the telecommunications firm 702 issues a password of up to 10 bytes to the subscriber 701.

In procedure T2, the telecommunications firm 702 operates the OpS 640 and sets the password issued to the subscriber 701, the contracted access point, the allocated bandwidth, and other service details in the database 603 of the OLT 600.

In procedure T3 and procedure T4, the subscriber 701 inputs the password of up to 10 bytes, which was issued by the telecommunications firm 702, into the password storing unit 625 of the ONU 620 that was purchased, and connects the purchased ONU 620 to a subscriber line (the branch optical fiber 632).

In procedure T5, the OLT 600 monitors the connection/disconnection of the new ONU during the ranging process according to the ranging method B. Upon detecting the connection of the new ONU 620, the OLT 600 acquires the unit number from the newly connected ONU 620, provides identification information, sets a delay time, and puts the ONU 620 in the operating state.

In procedure T6, the OLT 600 sends a Request_password message that is a control message (PLOAM message) for requesting the ONU 620, which has been put in the operating state, to provide the password.

In procedure T7, the ONU 620 receives the Request_password message and responds with a Password message that is a response message defined as a PLOAM message after inclusion of the password set in procedure T3.

In procedure 8, the OLT 600 extracts the password from the received Password message and searches the database 603 using the password as a search key.

In procedure T9, if a matching password exists in the database 603, the OLT 600 extracts the service details from the database 603 and performs connection setting and allocated bandwidth setting for the corresponding ONU 620. Services can thus be started immediately after connection for the subscriber using the newly connected ONU 620.

If the matching password does not exist in the database 603, this means that the subscriber has not made a contract. Therefore, the OLT 600 does not provide services to the corresponding ONU, thereby preventing illegitimate use.

Thus, in the first embodiment, the OLT uses a password to specify a subscriber of an ONU for which ranging has been completed autonomously. Therefore, services can be started immediately after an ONU, purchased at a mass retailer by a subscriber who has made a contract, connects to the network. The plug-and-play function that is demanded of a PON system can thus be realized under an open terminal environment.

### Second Embodiment

FIG. 8 is a block diagram of a PON system according to a second embodiment of the present invention. In FIG. 8, components that are the same as or equivalent to the components shown in FIG. 6 (First Embodiment) are provided with the same symbols. Here, portions concerning the second embodiment will mainly be described.

As shown in FIG. 8, in the PON system of the second embodiment, an ONU 820 is provided in place of the ONU 620 shown in FIG. 6 (First Embodiment). In the ONU 820, a subscriber information storing unit 825 that stores an address, name, and other subscriber information that a subscriber sets is provided in place of the password storing unit 625 of the ONU 620. Moreover, the subscriber information storing unit 825 is connected to the monitoring/controlling unit 623.

In the second embodiment, a case of using control messages of monitor control channels disposed between the OLT and ONUs is described as another example of realizing a plug-and-play function of specifying a new subscriber and then immediately starting services under an open terminal environment.

The plug-and-play function realized by the PON shown in FIG. 8 will now be described with reference to FIG. 9. FIG. 9 is a sequence diagram of an optical network unit connecting procedure implemented in the PON system shown in FIG. 8.

In FIG. 9, a subscriber 901 and a telecommunications firm 902 bind a contract in procedure T10.

In procedure T11, the telecommunications firm 902 operates the OpS 640 and sets the address, name, and other subscriber information of the subscriber 901, the contracted access point, the allocated bandwidth, and other service details in the database 603 of the OLT 600.

In procedure T12 and procedure T13, the subscriber 901 inputs the name, address, and other subscriber information in the subscriber information storing unit 825 of the ONU 820 that was purchased, and connects the purchased ONU 820 to a subscriber line (the branch optical fiber 632).

In procedure T14, the OLT 600 monitors the connection/disconnection of the new ONU during the ranging process according to the ranging method B. Upon detecting the connection of the new ONU 820, the OLT 600 acquires the unit number from the newly connected ONU 820, provides identification information, sets a delay time, and puts the ONU 820 in the operating state.

In procedure T15, the OLT 600 sets a monitor control channel between itself and the ONU 820 that has been put in the operating state.

In procedure T16 and procedure T17, the OLT 600 uses a control message of the set monitor control channel to request the ONU 820 to provide the subscriber information, and the ONU 820 provides the subscriber information, set in procedure T12, to the OLT 600.

In procedure T18, the OLT 600 searches the database 603 using the received subscriber information as a search key.

In procedure T19, if matching subscriber information exists in the database 603, the OLT 600 extracts the service details from the database 603 and performs connection setting and allocated bandwidth setting for the ONU 820. Services can thereby be started immediately after connection for the subscriber using the newly connected ONU 820.

If the matching subscriber information does not exist in the database 603, this means that the subscriber has not made a contract. Therefore, the OLT 600 does not provide services to the corresponding ONU, thereby preventing illegitimate use.

Thus, in the second embodiment, the OLT uses subscriber information to specify a subscriber of an ONU for which ranging has been completed autonomously. Therefore, services can be started immediately after an ONU, purchased at a mass retailer by a subscriber who has bound a contract, connects to the network. Thus, as with the First Embodiment, the plug-and-play function demanded of a PON system can thus be realized under an open terminal environment.

In the method of specifying subscribers using PLOAM messages, the number of bytes that can be used in a control message is limited. Therefore, only a password that can be expressed with a low number of bytes is used, as described in the first embodiment.

On the other hand, in the method of using the monitor control channel between the OLT and the ONU as in the second embodiment, there is no limit on the amount of information exchanged between the OLT and the ONU. Therefore, more information besides the password, such as the address and name, can be exchanged between the OLT and the ONU to specify a subscriber.

### INDUSTRIAL APPLICABILITY

The present invention enables autonomous ranging to be performed on an optical network unit that is purchased and installed arbitrarily by a subscriber, and the subscriber and the service details to be specified. Therefore, the present invention is favorable for realizing a plug-and-play function required of a PON system in an open terminal environment.

1-6. (canceled)

7. A passive optical network system comprising:
an optical line termination; and
a plurality of optical network units that are respectively connected to an optical line termination via an optical transmission line; wherein
the optical line termination includes
a database configured to store subscriber recognition information and service details in association with a subscriber,
an issuing unit that, upon detecting a connection with a new optical network unit while performing autonomous ranging, issues a control message to request the new optical network unit to provide subscriber recognition information, and acquires the subscriber recognition information, and
a setting unit that, based on acquired subscriber recognition information, searches the database and specifies the subscriber and the service details, and performs bandwidth setting and connection setting based on specified service details, and
each of the optical network units includes
a storing unit that stores subscriber recognition information input by a subscriber; and
a notifying unit that receives, from the optical line termination, a control message requesting for the subscriber recognition information, and issues a response message that notifies the subscriber recognition information.

8. The passive optical network system according to claim 7, wherein
the subscriber recognition information is a password that specifies the subscriber, and
the control message and the response message are sent and received using any one of a physical layer and a monitor control channel.

9. The passive optical network system according to claim 7, wherein
the subscriber recognition information includes the subscriber's address, name, and other subscriber information, and
the control message and the response message are sent and received using a monitor control channel.

10. A method for connecting a plurality of optical network units included in a passive optical network system to an optical line termination via an optical transmission line, comprising:
the optical line termination preparing a database that is configured to store subscriber recognition information and service details in association with a subscriber;
the optical line termination detecting a connection with a new optical network unit while performing autonomous ranging;
the optical line termination issuing a control message to request the new optical network unit to provide subscriber recognition information, wherein the act of issuing is performed after the act of detecting;
each of the optical network units storing subscriber recognition information input by a subscriber;
each of the optical network units receiving from the optical line termination, a control message requesting for the subscriber recognition information;
each of the optical network units issuing a response message including the subscriber recognition information;
the optical line termination searching the database based on acquired subscriber recognition information to thereby specify the subscriber and the service details; and
the optical line termination performing bandwidth setting and connection setting based on specified service details.

11. The method according to claim 10, wherein
the subscriber recognition information is a password that specifies the subscriber, and
the control message and the response message are sent and received using any one of a physical layer and a monitor control channel.

12. The new method according to claim 10, wherein
the subscriber recognition information includes the subscriber's address, name, and other
the control message and the response message are sent and received using a monitor control channel.
